(19) United States
(12) Patent Application Publication
(10) Pub. No.: US 2011/0093404 A1
(43) Pub. Date: Apr. 21, 2011

(54) SYSTEMS AND METHODS FOR FACILITATING INTERACTIONS BETWEEN DATA SUBSCRIBERS AND USERS SHARING A HEALTH CONDITION

(76) Inventors: Gregory B. Lawless, Century, FL (US); Russel O. Potts, San Francisco, CA (US); Erin Potts, San Francisco, CA (US)

(21) Appl. No.: 12/906,048

(22) Filed: Oct. 15, 2010

Related U.S. Application Data
(60) Provisional application No. 61/252,122, filed on Oct. 15, 2009.

(51) Int. Cl. G06Q 99/00; G06F 15/16

(52) U.S. Cl. 705/319; 709/204

(57) ABSTRACT

A system is disclosed that enables peer-to-peer interactions between individual users sharing an interest in a health condition. The system provides the service in return for the user providing the system with data relating to lifestyle and health of the user, including those relating to diet, exercise, use of diagnostic and drug delivery devices, medication frequency and compliance with the medication regimen. The health profile data is used to generate parameters including a level of expertise of a user and a quality indicator for the data provided by the user. The database containing health profile data is accessible to a subscriber who queries the data anonymously to retrieve information.

### FIELD OF THE INVENTION

This invention relates generally to health management and specifically to management of chronic health conditions in which the lifestyle of the individual plays a major part. More specifically, the invention relates to systems and methods for facilitating interaction between individuals who share a health profile so that they may share information for mutual benefit relating to managing or treating the disease. The invention is also related to systems and methods for obtaining high quality health related data from individuals that would be useful for disease treatment.

### DESCRIPTION OF THE RELATED ART

Chronic diseases are long-lasting conditions that can be controlled but not readily cured, and they affect the population worldwide. As described by the Centers for Disease Control, chronic diseases are the leading cause of death and disability in the U.S., accounting for 70% of all deaths in the U.S., which is 1.7 million each year. Data from the World Health Organization show that chronic disease is also the major cause of premature death around the world even in places where infectious diseases are rampant. Among the chronic diseases, heart disease, diabetes, HIV/AIDS, and cancer are considered major life-threatening conditions, apart from others such as obesity, allergy, asthma, glaucoma, and epilepsy. Management of chronic disease forms a major part of health care expenditure worldwide.

Current estimates put U.S. health care spending at approximately 15.3% of GDP, according to WHO reports. The health share of GDP is expected to rise to 20% percent of GDP by 2017. Of the amount spent on health care in the U.S., nearly a third is spent on medication and diagnostic and medical devices—10% on pharmaceuticals and 23% on diagnostic laboratory services and medical device manufacturers, according to the Pharmaceutical Research and Manufacturers of America. The above statistics underline the economic importance of health care management for individuals as well as the medical device and pharmaceutical industries.

Except in a hospital or nursing home setting, individuals with chronic diseases are often required to self-monitor their symptoms or health parameters using a variety of medical devices and self-administer medication through various means, such as orally or transdermally. They may be required to monitor their physiological status, sometimes several times a day, and self-administer medication at a similar frequency. For such individuals, the chronic disease and its management form part of their daily routine and have a profound impact on the individual's lifestyle.

Individuals are often required to monitor themselves and take medication in anticipation of activities such as exercise and eating, particularly in conditions such as diabetes and heart disease. In monitoring and compliance, the advice of the primary caregiver, such as the physician, is available and contact with this caregiver is periodically renewed, for example every three to six months or perhaps more frequently, depending on the severity of the condition. Despite such contact, the individual's comfort level in carrying on with monitoring and medication compliance varies widely, depending on their level of education, social milieu, family conditions, etc. Studies reveal that individuals with diabetes, for example, feel a great need for exchanging information with peers on various aspects of the use and effectiveness of medical devices used both for monitoring blood glucose and for delivery of drugs to control the blood glucose.

The Internet and the World Wide Web have emerged as an important platform for information exchange that was previously unavailable. Queries concerning an individual's state of health or the use of diagnostic and drug delivery devices can be directed at Websites such as WebMD® or RealAge®. When a query is directed at these sites, an expert considers the user's query and sends a response in an offline information exchange. Another alternative is for the individual to look up the frequently asked questions (FAQ) on various Websites. A major difficulty with this kind of exchange is that it is offline and not immediately interactive. A second and more serious limitation is that these responses are sent down from an expert's perspective rather than from a peer's perspective, and might lack insights into practical problems associated with a particular make of device, for example. A third difficulty is the rapid obsolescence of product knowledge and frequent lack of experience with new models based on improved technologies coming to market. One way to address these difficulties is to provide for online peer-to-peer interactions between groups of users sharing similar health conditions.

Existing ways of exchanging information online include social networking Websites such as Facebook®. However, these Websites provide virtually unfettered access to the entire Web, which makes it particularly difficult for people with similar interests to locate each other and interact. While such Websites generally provide opportunities for interaction when members of the group know each other, a different model providing for effective peer interactions between individuals sharing a common health condition presents an unmet need.

While users of medical devices have difficulties sharing experiences and information, other kinds of difficulties confront the device and drug industries in terms of the high cost of information gathering. Spending on drugs to treat diabetes stood at $9.88 billion in 2005 according to leading Web portal Bio-Medicine; for the same period the total US Government spending on diabetes was $80 billion, which is indicative of the economic importance of diabetes management.

The drug and device industries spend millions of dollars a year to collect feedback from users, caregivers, and at points of sale so as to improve their products and services. However, this kind of direct survey has serious limitations of quality, since respondents may not spend sufficient time to answer the survey queries. More aggressive approaches involving incentivization, for example, often lead to biased responses. At the other end of the information chain, well informed or “expert” users often find the industry unresponsive to the level of feedback they are prepared to give, as there is no mechanism to validate the level of expertise or to identify, a priori, such expert individuals.

Despite the high cost of direct data gathering, the information so obtained is therefore of poor or doubtful quality. Further, the feedback must be gathered on a continual or recurring basis as product lines are improved and new products released from time to time. There is therefore a need for a different model, allowing the health care industry to obtain higher quality survey data directly from actual users.

### SUMMARY OF THE INVENTION

Methods and systems for facilitating interactions within a group sharing a specified health condition are disclosed. In one aspect, the system obtains survey data from a group of users using queries on parameters relevant to their state of health, such as the use of diagnostic devices, use and frequency of medication, compliance with a prescription regimen, dietary and exercise habits, and lifestyle profile. The system maintains a database of users with associated response data. In one aspect the system allows users to communicate with other users by automatically matching them with others having similar profiles. In another aspect the system allows users to choose the profile and identity of the other user(s) for interaction. In one aspect the system maintains anonymity among users while facilitating such interactions.

In one aspect the system computes a level of expertise for a user, based on factors including use of diagnostic devices, use of therapy devices, medication dosing, compliance with medication, visits to a physician, visits to a specialist, exercise and dietary habits. The system may then qualify its matching of users based on computed expertise levels. Optionally, computation of the user expertise level may include validation by direct contact with the user.

In another aspect the system facilitates interactions between one or more data subscribers and a group of users sharing a health condition. The system obtains survey data from the group of users, the survey data being responsive to inquiries that are relevant to a health profile of the users, and uses the survey data to compute a quality indicator for the data obtained from each user. The system maintains a database of users with associated survey data and quality indicators, and allows the data subscribers to query the database to retrieve information based on the obtained survey data, wherein the retrieved information is qualified based on the associated quality indicators. Computing the data quality indicator may be based on factors including frequency of diagnostic testing, frequency of medication dosing, compliance with medication, visits to a physician, visits to a specialist, exercise habits, and dietary habits of the user. In one aspect, the system maintains confidentiality and/or anonymity between the users and the subscriber.

In one aspect the system is configured to receive input from one or more user devices such as diagnostic devices, drug delivery devices, stimulators, and monitoring devices. The system may then provide a unified data interface to the user by integrating the data from such multiple devices.

In another aspect, the system is applicable to users with a condition such as diabetes, heart disease, breast cancer, obesity, Parkinson's disease or HIV/AIDS and can be implemented in any interactive network such as a computer or a mobile network or a hybrid network.

These systems, and related methods, are described in more detail below.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram showing a system for peer interaction between users sharing a health condition and subscribers accessing user data related to the condition.

FIG. 2 is a flow diagram showing the registration process for new users.

FIG. 3 is a block diagram illustrating anonymous interactions between users sharing a health condition.

FIG. 4 shows anonymous interactions between a subscriber and a group of individual users sharing a health condition.

### DETAILED DESCRIPTION OF THE PREFERRED EMBODIMENTS

Although the detailed description contains many specifics, these should not be construed as limiting the scope of the invention but merely as illustrating different examples and aspects of the invention. It should be appreciated that the scope of the invention includes other embodiments not discussed in detail. Various other modifications, changes and variations which will be apparent to those skilled in the art may be made in the arrangement, operation and details of the method and apparatus of the present invention disclosed herein without departing from the spirit and scope of the invention as described here.

The methods and systems disclosed herein allow users, who share similar health conditions or health concerns or similar interests in health conditions or health concerns, to interact with each other using electronic devices such as computers or mobile devices connected to the Internet or other networks. The system allows users to disclose information about themselves, such as data about their state of health, lifestyle, diet, use of diagnostic devices, therapy devices, therapeutic agent regimen, health concerns, family health history, etc. The system stores such user data in a data repository such as a database. Users may then use the system to communicate or otherwise interact with each other, and they may choose to remain anonymous in such interactions, or they may choose to disclose one or more aspects of their private data or identity.

In one embodiment, the system may aggregate and/or mine the stored user data and make the resulting information available to interested parties, such as data subscribers, who may be commercial entities in the field of healthcare with an interest in such data. The system may provide such data access to subscribers in a manner wherein the users and subscribers remain anonymous to each other, to protect and preserve privacy and confidentiality.

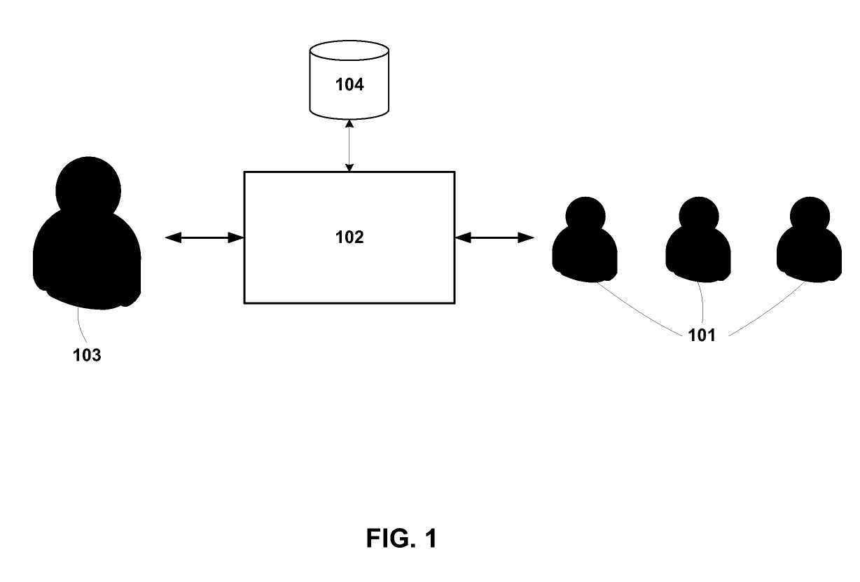

FIG. 1 is a block diagram showing a system in accordance with one embodiment of the present invention. System 102 interfaces with one or more users 101, and one or more subscribers 103. A user 101 desirous of interacting with other users 101 who share the same or similar health conditions, interest or concerns may register with system 102 and provide information about his/her health condition to system 102. System 102 is a computer based system, such as a server or distributed system, and stores and maintains such data using a data repository 104, such as a database.

As mentioned above, the system 102 facilitates peer interactions among registered users 101, and may further provide one or more subscribers 103 with one or more levels of access to the data stored in database 104, or to information derived from the stored data. The subscribers 103 are envisaged to be entities that have an interest in such data, such as those manufacturing drugs or medical devices to treat health conditions relevant to one or more users 101, or other entities interested in high-quality market research data related to specific health conditions and market segments.

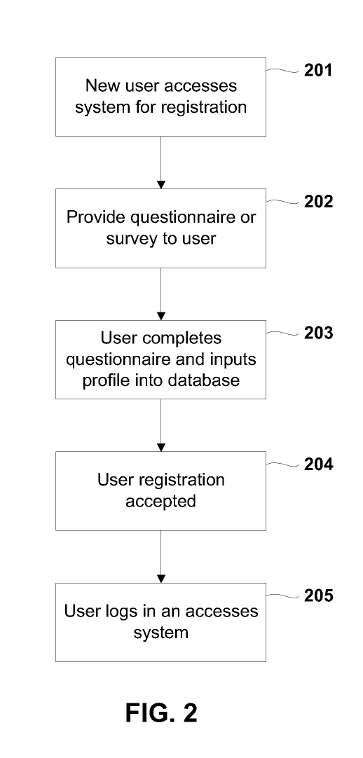

FIG. 2 is a flow diagram showing a process for registering users 101 with the system 102, in accordance with one embodiment of the present invention. At step 201, a user 101 with a health condition or health concern accesses the system 102. At step 202, the system 102 provides the user 101 with an appropriate questionnaire or survey. The questionnaire may relate to various aspects of the user's 101 health, including but not limited to: the user's 101 health conditions, lifestyle, diet, exercise habits, use of diagnostic devices, use of therapy devices such as stimulators or injection devices, frequency and compliance in the use of therapeutic drugs specific to the user's health conditions, family health history, etc.

At step 203, the system 102 records responses provided by the user 101. Optionally, the system 102 may evaluate the user's 101 responses for completeness or consistency. The system 102 may further request and record other related information about the user 101, such as the user's 101 name, address, contact information, etc. Once the profile of the new user 101 is complete, the system 102 accepts the registration at step 204. At step 205, once registration is complete, the user 101 may log into system 102 to access the services provided by the system 102. Upon login, the system 102 provides the user 101 with one or more of the available services, including but not limited to: peer interaction between users 101 sharing the same or similar health conditions, concerns or interest, market information on medical devices or treatments, reviews on products or services, regulatory information, expert opinions, help or data on usage or performance of medical devices, etc.

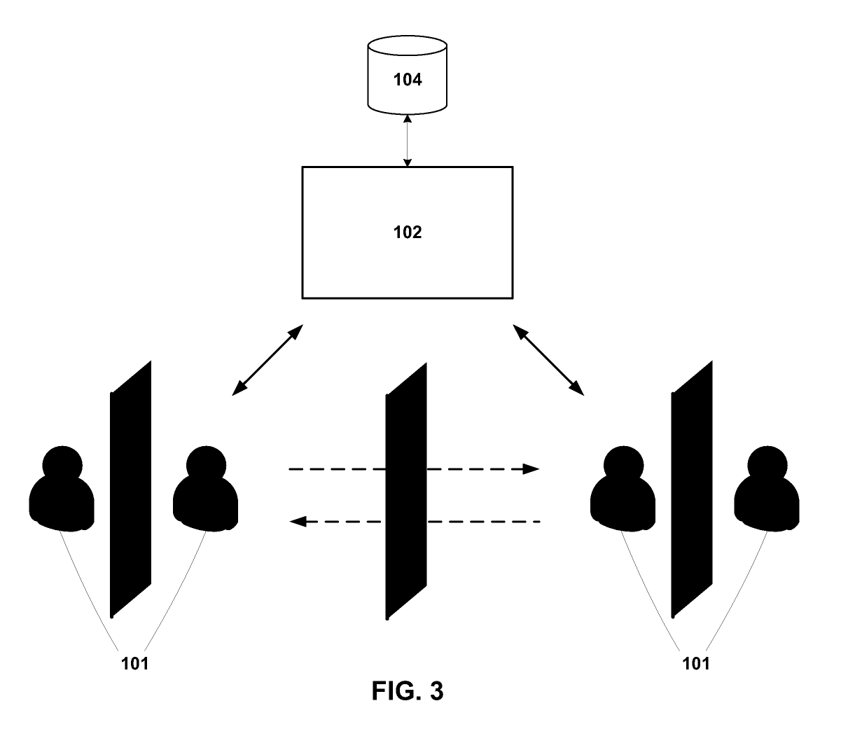

FIG. 3 is a block diagram showing the system 102 of one embodiment of the present invention configured to enable peer interactions between users 101 sharing a health condition, interest or concern, in accordance with an embodiment of the present invention. As described above, the system 102 maintains information provided by users 101 in database 104. In one embodiment, users 101 may browse or search for other users 101 and initiate interaction with them using one or more user interfaces provided by the system 102. Such user interfaces may comprise offline messaging, instant messaging, message boards, blogs, voice or video messaging, social networking, SMS, MMS, or other forms of computer implemented communication, as should be obvious to those of ordinary skill in the art.

Optionally, the system 102 may generate a suggestion or recommendation that a user 101 initiate interaction with another user 101. The system 102 may make such suggestions in a variety of ways. By way of example, the system 102 may identify users 101 whose profiles meet a certain similarity threshold, and suggest that they connect. By way of another example, the system 102 may allow users 101 to post queries or items of interest to a public or private messaging repository, and may examine the profiles or activities (such as history of posting, comments, interactions, etc.) of other users 101 in order to identify and make interaction suggestions. In general, the system 102 may comprise any type of logic, including referring to or correlating with related user data hosted at other service providers such as email hosting or social networking services, to suggest connections to users 101.

Optionally, the system 102 may base such suggestions on a variety of parameters including age, sex, level of expertise, number of years with a specific health condition, education level or any other qualifying parameters as computed by the system 102 and encompassing such factors. Additionally and optionally, the information used to generate a parameter indicative of the level of expertise of the user may include factors such as frequency of use of diagnostic or therapy devices, frequency of use of medication, frequency of visits to a general physician, frequency of visits to a specialist, compliance with the medication regimen, dietary habits, level and frequency of exercise, or other similar information. The level of expertise may also be used to qualify the user 101 during peer interactions with other users 101, or to more highly rank the relevance of data obtained from a user 101 identified as having a higher level of expertise than that of other users 101, etc.

While the users 101 are free to use the interaction facilities provided by system 102 for any type of communications, it is contemplated that in particular such interactions may include a variety of communication types such as feedback or exchange of notes on the use of the latest medical devices, such as diagnostic and/or drug delivery devices, stimulators, and the like; or on the use or side effects of new medications that may come on to the market. As described above, the identity or other private profile information of the users 101 may be visible to each other, or the interactions can be anonymous, at the option of the users 101 themselves. For example, a user 101 may selectively choose to reveal some otherwise private information to another user 101 after some level of trust has been established.

In another aspect of the invention, the validation of the expertise level of a user 101 may include direct contact with the user to physically verify the authenticity of the data provided to the system 102. For example, essential user profile data such as number of years of user experience with medical devices, physician or specialist consultations, or other such information, may be verified during such direct contact. Optionally, when aggregating, mining, or otherwise processing such data for presentation to a subscriber 103, directly verified data may be given higher weight or relevance than similar data that has not been directly verified.

In another aspect of the invention, the system 102 receives input from a number of devices (not shown) and provides an integrated data interface to users 101. Such data may originate from a variety of devices, including but not limited to: diagnostic devices such as blood glucose monitors, medication injection devices such as pumps, therapy devices such as stimulators, or other devices such as pill dispensers, personal digital assistants (PDAs), mobile phones, computers, devices using radio-frequency identification (RFID) technology, etc. In such an embodiment, the system 102 may provide an integrated data interface to users 101 comprising a conveniently unified view of data obtained from such devices. It is contemplated that such integration would help in better physiological monitoring and eliminating or minimizing errors in medication dosing or compliance, thereby facilitating better management of the user's health condition.

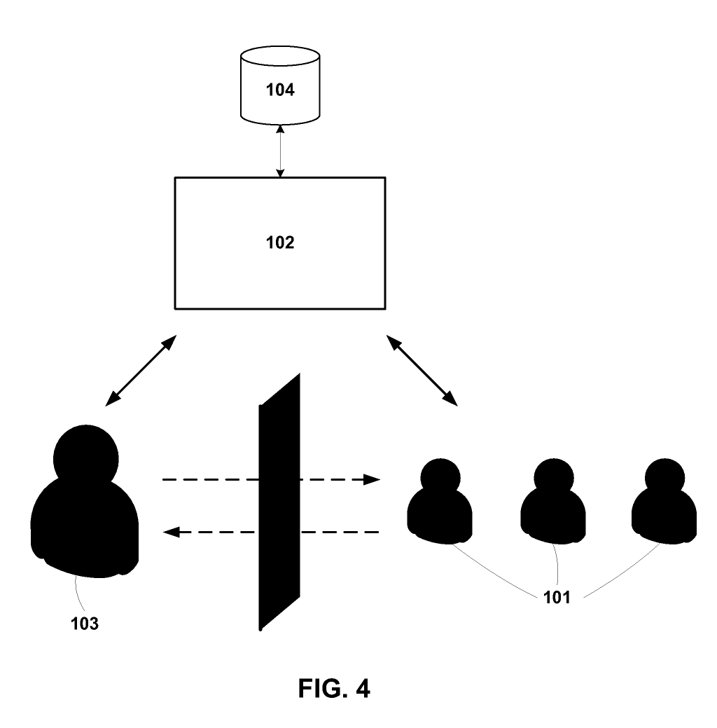

In another embodiment, the system 102 may provide for a subscriber 103 to query the database 104, for example as shown schematically in FIG. 4. In such an embodiment, the system 102 may allow a subscriber 103 to query the database 104 to retrieve value-added information that is otherwise not easily available. For example, in the case of users 101 with diabetes, such value-added information may be obtained in the form of feedback on medical devices such as glucose monitors or drug infusion pumps from users 101 with a qualified level of expertise. The system 102 may compute quality indicators for the data obtained from the users 101 in order to meet desired data quality standards by including data provided by users 101 who meet a quality threshold. Computing such quality indicators may be based on factors such as, but not limited to: frequency of diagnostic testing, frequency of medication dosing, compliance with medication, visits to a physician, visits to a specialist, exercise habits, and dietary habits of the user. Optionally, computing the data quality indicator may include response validation by direct contact with the user, as also described above.

In one embodiment, the system 102 is configured to maintain anonymity between the users 101 and subscribers 103 so that the feedback data remain substantially free of bias. Such anonymous interactions between users 101 and subscribers 103 are expected to provide higher quality survey data than when anonymity is absent.

Optionally, the system 102 may allow a subscriber 103 to present a customized questionnaire or survey to users 101. The subscriber 103 may selectively address the questionnaire to users 101, depending on specific characteristics selected from the user profile data. Such specific characteristics may include, but are not limited to: health conditions, lifestyle, diet, exercise, level of expertise, or other such factors.

The methods and systems of the present invention may be applied to any disease or health condition, including but not limited to: diabetes, heart disease, breast cancer, obesity, human immunodeficiency virus (HIV) infection, asthma, allergies, glaucoma, Parkinson's disease, and epilepsy.

In the context of diabetes care, the systems and methods of the present embodiments can be used by users 101 in several ways. For example: to compare the use, response, or performance of blood glucose monitors or drug delivery pumps; to compare management of diet and nutrition; to compare exercise routines; to compare methods to integrate testing and medication according to lifestyle choices; to advocate the latest trends in diabetes treatment, including new, convenient, or user-friendly devices, or forms of medication; etc.

Users with heart disease, obesity, Parkinson's disease, epilepsy, or similar conditions may advantageously share information including one or more of diet, lifestyle, feedback on performance of implants or stimulator devices, new treatment options, etc. Users with other conditions such as breast cancer, HIV infection, asthma, allergies, etc., may benefit by sharing a variety of information, such as new treatment options, new medications, new ways of administering medications, mutual counseling, and so on.

It is contemplated that, while the methods and systems of the present invention are useful in facilitating interactions among users and subscribers, they are not intended to be used to make recommendations of a medical or prescriptive nature to the individual user, but instead to play an informative and facilitative role.

Advantageously, the systems and methods of the present embodiments present a viable and sustainable model for interactions between users who share a health condition or concern, such as a chronic health condition. The users will receive the benefit of peer interactions, effectively in exchange for providing their health profile data and feedback regarding the use of lifestyle issues such as diet and exercise, therapeutic drugs and medical devices. Advantageously, the peer interactions are facilitated in a directed manner by certain aspects of the present embodiments that are not presently available through methods intended for general social interactions and social networking. Certain aspects of the present embodiments also fulfill the need for a readily accessible communication channel between users with a specific health condition that would facilitate rapid and effective dissemination of information. The system will be supported by a base of subscribers who are envisaged to be commercial entities in the health care industry. The subscribers would obtain valuable information not easily available by other means in a cost-effective manner on a short timescale relative to comparable methods of direct market survey. Additionally, the survey data obtained by the methods of certain aspects of the present embodiments would be less biased or skewed as compared to obtaining information via direct contact with survey respondents. The subscribers would be able to test ideas for prototypes, conduct highly directed market surveys, or address complaints and feedback from their existing devices in the market in a way that would bring substantial cost savings to the industry. In addition, the subscriber may query users in an iterative manner to refine ideas and concepts.

The methods and systems of the present embodiments may be implemented using a client/server computing architecture, peer-to-peer architecture, or any other suitable architecture for implementing the systems and methods disclosed herein, using devices which may optionally be mobile devices, and data communications which may use wired or wireless networks, as should be known to those of ordinary skill in the art.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A computer implemented method for facilitating information exchange interactions, comprising:
obtaining survey data from a group of users sharing an interest in a health condition, the survey data being responsive to inquiries that are relevant to a health profile of the users;
maintaining a database of users with associated survey data;
automatically identifying user matches based on user profile similarity; and
facilitating anonymous interactions between users.

2. The method of claim 1, wherein the inquiries include questions about a diagnosis, a treatment, a treatment regimen compliance, or a lifestyle of the users.

3. The method of claim 2, further comprising:
determining a level of expertise for each user based on the data obtained from that user, and making the level of expertise available to other users, thereby allowing users to interact with other users based on expertise levels.

4. The method of claim 1, wherein the health profile of the users is associated with diabetes, heart disease, breast cancer, obesity, or HIV infection.

5. The method of claim 1, further comprising facilitating interaction between a data subscriber and the group of users by:
using the survey data to compute a quality indicator for the data obtained from each user;
allowing the data subscriber to query the database to retrieve information based on the obtained survey data, wherein the retrieved information is qualified based on the associated quality indicators; and
maintaining anonymity between the users and the subscriber.

6. The method of claim 5, wherein the inquiries include questions about a diagnosis, a treatment, a treatment regimen compliance, or a lifestyle of the users.

7. The method of claim 6, wherein computing the data quality indicator is based on factors including frequency of diagnostic testing, frequency of medication dosing, compliance with medication, visits to a physician, visits to a specialist, exercise habits, and dietary habits of the user.

8. The method of claim 7, wherein computing the data quality indicator includes response validation by direct contact with the user.

9. The method of claim 5, wherein the health profile of the users is associated with diabetes, heart disease, breast cancer, obesity, or HIV infection.

10. A system for facilitating interactions within the group of users sharing an interest in a health condition, comprising:
a database configured to store survey data for the group of users; and
a processor coupled to the database and configured to:
obtain survey data from the group of users, the survey data being responsive to inquiries that are relevant to a health profile of the users;
maintain the database of users with associated survey data;
automatically identify user matches based on user profile similarity; and
facilitate anonymous interactions between users.

11. The system of claim 10, wherein the inquiries include questions about a diagnosis, a treatment, a treatment regimen compliance, or a lifestyle of the users.

12. The system of claim 11, wherein the processor is further configured to:
determine a level of expertise for each user based on data obtained from that user, and make the determined level of expertise available to other users, thereby allowing users to interact with other users based on expertise levels.

13. The system of claim 10, wherein the level of expertise is determined based on a frequency of diagnostic testing, a frequency of medication dosing, a compliance with medication, visits to a physician, visits to a specialist, exercise habits, and dietary habits of the user.

14. The system of claim 10, wherein the health profile of the users is associated with diabetes, heart disease, breast cancer, obesity, or HIV infection.

15. The system of claim 14, wherein the processor is further configured to receive input from one or more user devices comprising diagnostic devices, drug delivery devices, stimulators, or monitoring devices.

16. The system of claim 15, wherein the processor is further configured to provide an integrated data interface to the users.

17. A system for facilitating interaction between a data subscriber and a group of users sharing an interest in a health condition, comprising:
a database configured to store survey data for the group of users; and
a processor coupled to the database and configured to:
obtain survey data from the group of users, the survey data being responsive to inquiries that are relevant to a health profile of the users;
use the survey data to compute a quality indicator for the data obtained from each user;
maintain the database of users with associated survey data and quality indicators;
allow the data subscriber to query the database to retrieve information based on the obtained survey data, wherein the retrieved information is qualified based on the associated quality indicators; and
maintain anonymity between the users and the subscriber.

18. The system of claim 17, wherein the inquiries include questions about a diagnosis, a treatment, a treatment regimen compliance, or a lifestyle of the users.

19. The system of claim 18, wherein computing the data quality indicator is based on factors including frequency of diagnostic testing, frequency of medication dosing, compliance with medication, visits to a physician, visits to a specialist, exercise habits, and dietary habits of the user.

20. The system of claim 17, wherein the health profile of the users is associated with diabetes, heart disease, breast cancer, obesity, or HIV infection.
